(19) United States
(12) Patent Application Publication
(10) Pub. No.: US 2006/0010008 A1
(43) Pub. Date: Jan. 12, 2006

(54) Card record sytem

(76) Inventor: Catherine Metry, Gross Point Shores, MI (US)

Correspondence Address: MAUREEN STRETCH, 26 CHARLES ST., NATICK, MA, 01760, US

(21) Appl. No.: 10/885,326

(22) Filed: Jul. 6, 2004

(51) Int. Cl. G06Q 10/00

(52) U.S. Cl. 705/2

(57) ABSTRACT

A system for storing record information associated with an identifier for an entity, so that the entity can request that the record information be relayed to or from a terminal communicating with the system by presenting a device acting as the identifier for the entity.

### BACKGROUND OF THE INVENTION

1. Technical Field

This invention relates generally to the field of cards used for record purposes.

2. Background

Credit cards, having a credit value associated with them and debit cards, having a cash value associated with them are commonly used to purchase goods and services. Prepaid telephone cards are similar to debit cards, in that they have a cash value associated with them and are used to purchase time for telephone calls. Discount cards are also in use by which a customer can obtain a discount on presenting the cards at purchase. All of these cards can be said to have a monetary cash or credit value associated with them.

While some credit card companies provide the card users with an itemized list of purchases on monthly invoices, some do not. Debit cards often do not provide itemized purchase data, but simply identify a location of purchase and the amount, such as “Purchase from Marshall Fields on Jul. 4, ______, in the amount of $29.95. USD.” While some debit cards can be used as credit cards, neither debit nor credit cards work interchangeably with a number of different credit card vendors.

Discount cards, or loyalty cards, such as those issued by supermarket chains, typically entitle a customer to a discount at the cash register and provide the issuer with marketing information about consumer purchases, but discount cards do not provide the users with an itemized list of purchases accessible at any time. Ordinarily, discount cards cannot be used as credit or debit cards, either.

“Smart cards”, cards with an integrated circuit chip embedded in the card, or small pocket computers have been used to store purchased goods information in a portable format, but these smart devices are expensive as well as prone to loss and theft.

It is an object of the present invention to provide a system for storing record information associated with an identifier for an entity, so that the entity can request that the record information be relayed to or from a terminal communicating with the system by presenting a device acting as the identifier for the entity.

### SUMMARY OF THE INVENTION

A system for storing record information associated with an identifier for an entity, so that the entity can request that the record information be relayed to or from a terminal communicating with the system by presenting a device acting as the identifier for the entity.

### BRIEF DESCRIPTIONS OF THE DRAWINGS

FIG. 1 is a schematic drawing of the invention.

FIG. 2 is a schematic drawing of the database of the present invention.

FIG. 3 is a schematic drawing illustrating typical database entries of the present invention.

FIG. 4 is a schematic drawing of the prior art.

FIGS. 5-8 are flow diagrams of the present invention.

FIGS. 9-10 are schematic drawings of screen displays of the present invention.

FIG. 11 is a schematic drawing of the database of the present invention showing the use of libraries.

FIG. 12 is a schematic drawing of a screen display of the present invention.

FIGS. 13-15 are schematic drawings of illustrative libraries stored with of the present invention.

FIGS. 16-18 are schematic drawings of compilations using the present invention.

FIGS. 19A-23 are schematic drawings of types of record information stored using the present invention.

FIG. 24 is a schematic drawing showing the use of biometrics as identifiers in the present invention.

FIG. 25 is a schematic drawing illustrating typical participating users of the present invention.

FIG. 26 is a schematic drawing illustrating use of the present invention for contests and lotteries.

FIG. 27 is a schematic drawing illustrating the use of the present invention for voting.

### DETAILED DESCRIPTION OF THE INVENTION

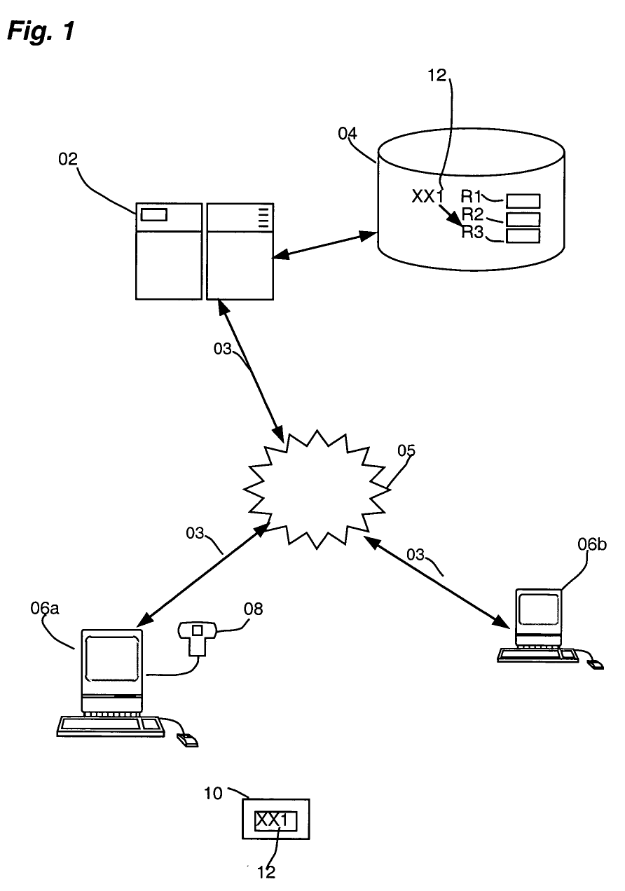

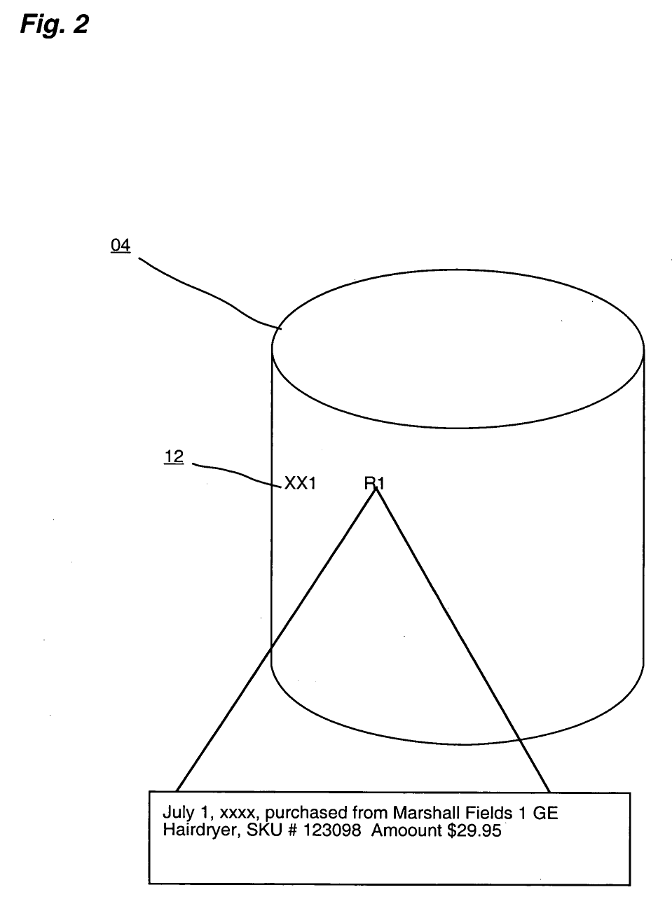

In FIG. 1, an overview of the present invention is shown. A card 10, having an identifier 12, can be scanned by scanner 08 at terminal 06a for relaying identifier 12 from terminal 06a over communications pathway 03 to a database 04. In the embodiment shown, communications pathway 03 is a connection to the Internet 05, where the connection is made by a modem with dialup or DSL or similar high speed access. However, those skilled in the art will appreciate that any kind of communications pathway could be used without deviating from the spirit of the present invention. For example, private networks could be used, as could virtual private networks, wireless and satellite networks and so on. Computer system 02 operates and controls database 04 in the embodiment shown. Those skilled in the art will appreciate that computer system 02 can be as small as a hand-held personal data assistant (PDA), or a personal computer or workstation communicating with a single hard drive for a database 04, to as large as a distributed computing system on a network communicating with a plurality of RAID disk drives or other mass storage devices containing database 04.

In the embodiment shown in FIG. 1, identifier 12 is associated with a single entity. In most cases, an entity is an individual person, but it could also be a corporate or educational or similar entity, such as a business organization, a non-profit organization, a hospital and so on. Identifier 12 is used by system 02 to locate record information R—records R1, R2, and R3 in this example, associated with identifier 12 in database 04.

In the embodiments shown, identifier 12, does not have any cash or credit value. That is, unlike a credit card number or a debit card number or discount card number, it does not inherently represent any cash or credit or discount. Instead, it is used to locate record information R associated with the entity.

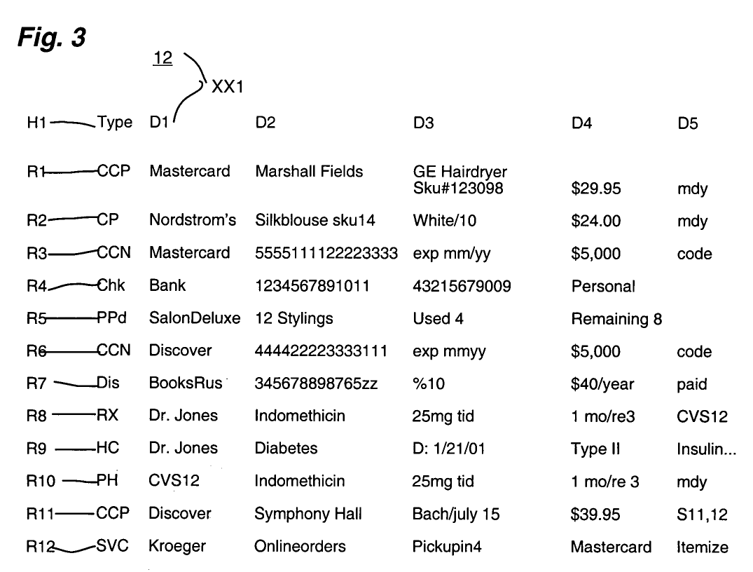

Turning briefly to FIG. 3, some of the types of record information R which can be associated with an identifier 12 in database 04 are shown. At header H1, type and descriptor headers are shown for purposes of illustration. In the embodiment shown, a record of information can be classified according to type, such as CCP for credit card purchase, CP for Cash purchase, CCN for Credit Card Number, Chk for checking account number, Ppd for prepaid items, Dis for discount card number, RX for prescription data, HC for healthcare data, PH for pharmacy data, SVC for service, and so on. Those skilled in the art will appreciate that other type indicators can be used without deviating from the spirit of the invention. For example, number codes can be assigned to each type of record, as can alphanumeric codes, or keywords.

In the embodiment shown in FIG. 3, Descriptors D1 through Dn are used to define the kind of information contained therein. For example, in R1, where the type indicator is CCP for Credit Card Purchase, descriptor D1 identifies the credit card and descriptor D2 identifies the vendor from whom the purchase was made. Descriptor D3 describes the item or service purchased in sufficient detail to serve as a receipt for purchase. In the example shown in FIG. 3, the vendor's SKU number as well as the manufacturer's name for the item are included. Descriptor D4 is the price paid, and Descriptor D5 is the date of purchase. At record R2, for example, a cash purchase is shown from the vendor Nordstrom's for a silk blouse. The same kind of receipt information is stored in record R2. Thus, if the entity loses the paper receipt given out by the store, card 10 of the present invention can be used to relay a copy of this receipt information to a terminal 06 at Nordstrom's if a return needs to be made. Those skilled in the art will appreciate that a customer can also use a wireless telephone or wirelessly connected personal data assistant (PDA) as terminal 06 to display the stored receipt in record R2, in database 04 if the store does not have, or have access to, its own terminal 06.

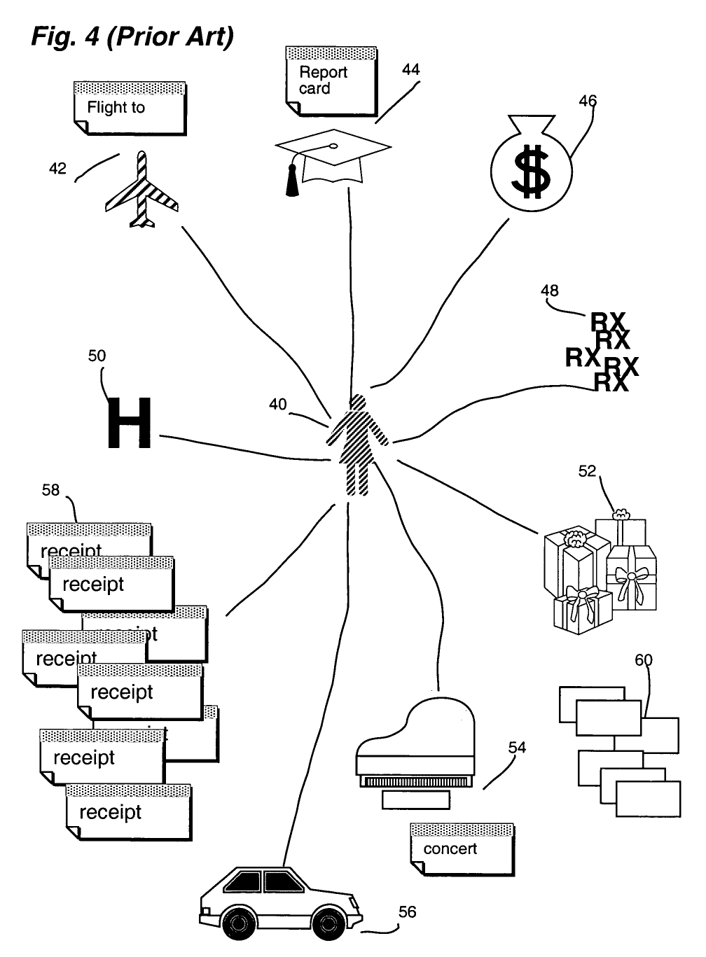

With reference briefly to FIG. 4, Prior Art, a typical modern individual 40 may need to keep records and information about a number of different items and events. For example, if the individual 40 is a mother of school age children, she probably needs to keep track of the children's school information 44, prescriptions 48 for herself, her husband and children, as well as health records 50 for the family. She probably also drives a car 56, and needs to keep track of registration, driver's license, insurance information, etc. related to the car. She probably buys many items for the household and gets large quantities of paper receipts 58 for them, which she may, or may not keep in a handy location. She probably purchases gifts and goods 52 for herself and others and books travel 42 and entertainment tickets 54.

Still in FIG. 4, if she is like many others, she may have several credit cards, debit cards and discount cards 60. If she goes grocery shopping, the grocery chain may have issued her a discount card 60a, but she may want to pay with a debit card 60b. So she will carry and present two cards at the grocery store. She and her husband may have multiple cards and copies of cards 60. They may have one pair of discount cards for a bookstore, another for an office supply house, another for home furnishings and so on. They may also have cards representing pre-paid or subscribed services, such as emergency road service cards, health insurance cards, membership cards, etc.

For many people, there is too much information of this type to carry around on a day to day basis. Thus, (and still in FIG. 4), it is quite possible that much of the paper receipt information and even some of the cards 60 get lost when the woman cleans out her purse or her husband cleans out his wallet. Even if a purchase was made with a credit card, some credit cards do not itemize purchases with descriptions that are sufficient to serve as receipts for credits and returns. Of course, if the item was paid for with cash, then the paper receipt is the only record-once lost, most stores will not allow returns or refunds. Oftentimes paper records such as receipts, tickets, and so on, are destroyed, or easily lost or hard to locate when they are needed most.

Returning now to FIG. 3, it can be seen that the present invention provides a person or entity with access to a comprehensive record information system. As shown in FIG. 3, not only can receipts be stored, but also other cards 60, can be stored by number. For example, at record R3 a Mastercard™ credit card number is stored, along with the expiration date, cash limit and use code. Similarly, at record R7, a discount card for BookPlace is stored, with the relevant information about its use. The present invention can also be used to store health care information, such as a patient's medical records R9, in which her physician, Dr. Jones has recorded the diagnosis of diabetes Type II and the indicated treatment. Prescription information is shown at record R10. A ticket is recorded as a credit card purchase at record R11, for a concert to be held July 15, for seats 11 and 12. Record R12, shows a compilation purchase and service, which allows the entity to order and pay for groceries online, and arrange to have the store put them out for pickup at a designated time.

In the embodiment shown in FIG. 3, card 10 of the present invention acts as a replacement for paper documentation of receipts, tickets, and so on. Instead of carrying (and possibly losing) a paper ticket, individuals using card 10 of the present invention can simply present the card to a participating vendor at the event or admissions gate. Referring back to FIG. 1, if the event is a concert, terminal 06a might be located at the concert hall, where the individual presents card 10, with his unique identifier 12. Once card 10 is scanned or read at terminal 06a, the receipt for the ticket can be sent from database 04. In this instance, the receipt is the ticket. If the ticket is for travel or transportation services, such as bus passes, train tickets, subway tokens or airline tickets, card 10 can supplant the need for all such paper or tokens. Additionally, while it is possible to use ordinary credit cards to purchase tickets online and print them at home, tickets printed on home printers are known to be highly subject to printing or ink errors, or both, thus leaving the consumer with tickets that cannot be scanned or read, causing the loss of the money paid for them. Paper tickets are also subject to theft, duplication and fraud, all of which can be minimized using card 10 and identifier 12 of the present invention.

Referring now to FIG. 3 again, it can be seen that card 10 of the present invention allows a user to minimize the number of credit, debit, cash, discount, membership, or subscription cards he or she carries around. With card 10 of the present invention, the individual can have a number of credit card, debit card, discount card, cash card, membership card, insurance card numbers, and so on, stored in database 04, and use card 10 to select a method of payment or select a card to use (insurance card, membership card, road assistance card, etc.). Since participating retailers use the present invention to store receipts in database 04, the invention also helps to insure that returns can be made accurately and quickly, if a customer requests one. While some credit cards do provide users with a monthly statement that itemizes purchases, and might be used for receipt purposes, they are only available monthly and can be easily lost. In some cases, if the monthly statement is lost, it can take up to six months to get a replacement to use for a receipt.

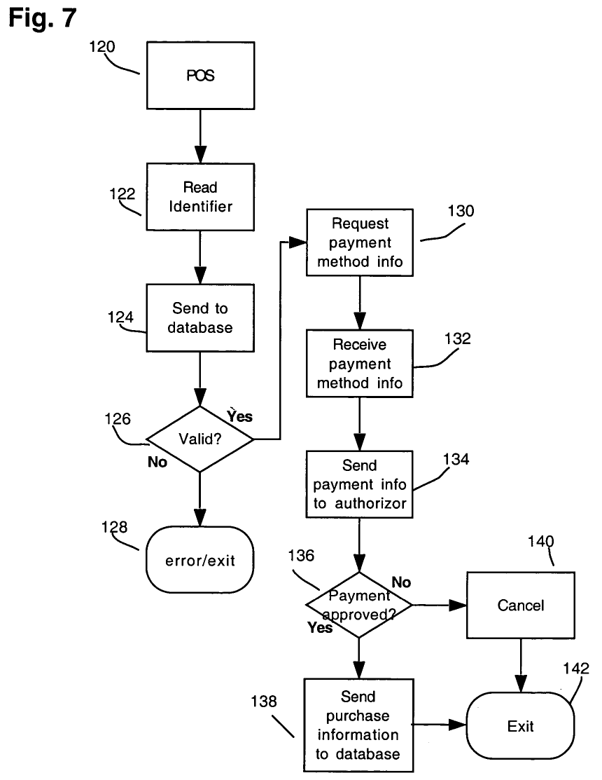

Using the present invention to select from one of several methods of payment can be seen in FIG. 7, where a point of sale (POS) system (Point of Sale Management System from Ash Systems, Inc.) has been modified to include software of the present invention to accept card 10 and allow the user to select a method of payment. As can be seen at step 120, the point of sale system, which may be operating in a terminal 06, reads identifier 12 of the present invention at step 122 and then at step 124 sends identifier 12 to database 04. Processing at system 02 and database 04 (not shown in this flowchart) uses conventional methods to check identifier 12 for validity (such as comparing it to stored identifiers 12 in database 04 and against lists of stolen identifiers 12) and sends a message back to the point of sale system. At decision block 126, the point of sale system checks to see if the result indicates identifier 12 is valid. If it is not, the point of sale system gives an error indicator and exits at step 128. If identifier 12 is valid, the point of sale system, modified according to the present invention, asks the entity which payment method to select at step 130. Assume the user selects a credit card number for which essential information such as expiration, etc. is also on file in database 04. That information is received at step 132 and sent to the credit card authorizor in step 134, using conventional methods. At step 136, the point of sale system checks to see if the payment has been approved by the authorizer. If not, the transaction is cancelled at step 140. If it is approved, the purchase information is sent, at step 138, to be stored in database 04 to act as a receipt for the entity for this purchase. Those skilled in the art will appreciate that other payment methods can be selected, such as debit cards, checking accounts, wire transfers, etc., without deviating from the spirit of the present invention.

As can be seen from FIG. 7, discount cards or loyalty cards can be handled in the same way at point of sale terminals 06.

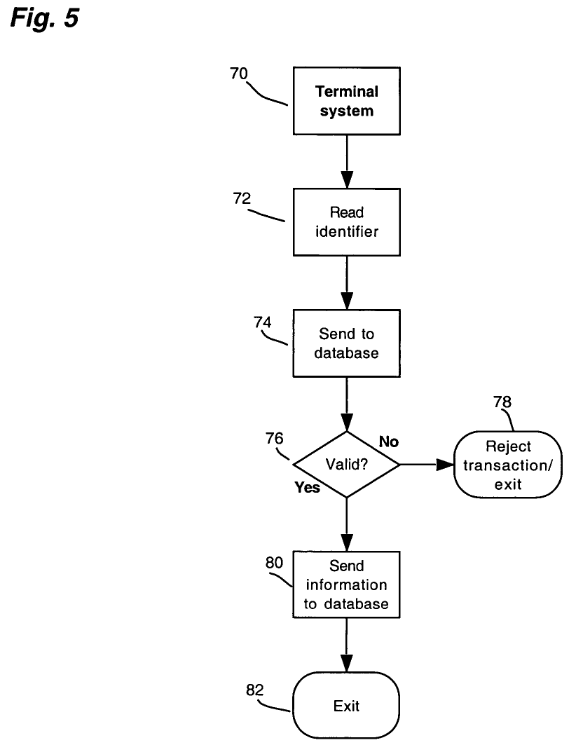

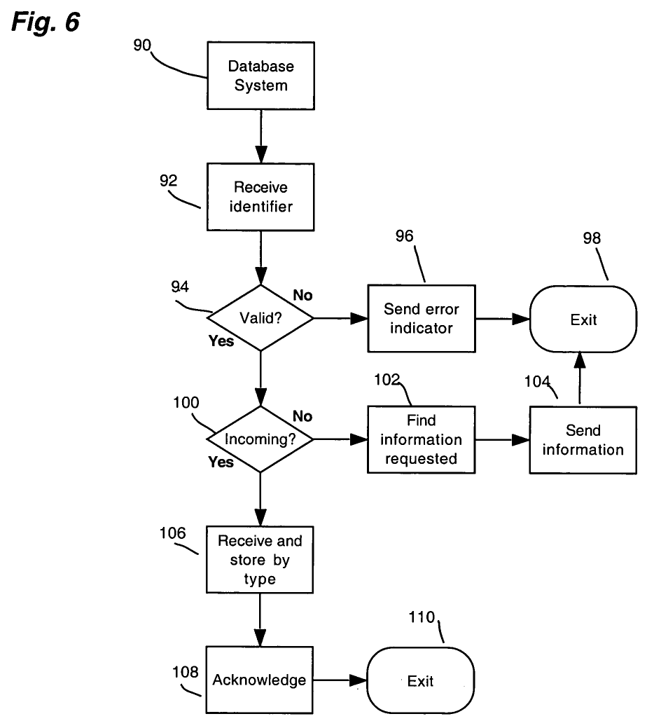

With reference now to FIG. 5, the simplest form of entry of receipt information is shown. There, at step 70 a terminal system for use at a terminal 06, is shown. At step 72, terminal 06 reads the identifier 12. In the embodiment shown in FIG. 1, a card 10, having a magnetic stripe or a bar code encoding the identifier 12 is shown. Participating terminals 06 which use the present invention have a card scanner or reader or keyboard. For magnetic stripe and bar code cards, inexpensive scanners and readers are available which make even home use of the scanner or reader feasible with a home computer acting as terminal 06. Alternatively, identifier 12 can be entered by using a keyboard. Returning to FIG. 5, once the identifier 12 is read, it is sent by the card record software at the terminal 06 to database 04 at step 74. In the embodiment shown, the present invention sends the information in TCP/IP message format over the Internet to a server system 02 (such as is shown in FIG. 1), which manages database 04. At the server system, identifier 12 can be validity checked. Depending on the implementation, an individual, user selected, personal identification number (PIN) number can be added to the validity checking procedure to insure the card is in the right hands. Additional security measures, some of which are described below, can also be used to insure the data is made available only to authorized requestors.

Returning to FIG. 5, at step 76 the card record software checks to see if identifier 12 was found to be valid by computer system 02 managing the database. If not, the activity is terminated at step 78. If identifier 12 is valid, the information which card record software wants to enter into the database is sent at step 80. Thus, the card record software illustrated in FIG. 5 might be used by a vendor to send a receipt for a purchase to database 04.

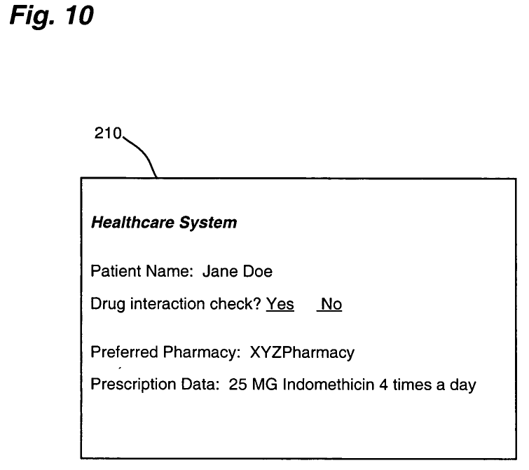

Alternatively, the same software can be used in a participating doctor's office or HMO to enter prescription information. Returning to FIG. 1, again, a patient may be at the doctor's office, where he presents his card 10, with its unique identifier 12, so the doctor or health care practitioner can enter prescription data at terminal 06a. In this example, terminal 06a may be a computer system or workstation at the doctor's office. The doctor or health care professional, enters prescription data for the patient after scanning in card 10 with its identifier 12. The data is stored for that individual in database 04. The computer system 02 which controls database 04 is programmed to address special actions, and in this case, it will recognize the code for a prescription, and use the patient entity's previously selected preferences, to send the prescription data to a pharmacy, to have the prescription filled by the time the entity has previously specified. In FIG. 1, terminal 06b would be located at the pharmacy, and since this pharmacy has been previously designated by the entity, the prescription data would be sent to the pharmacy's terminal 06b to be ready in two hours. Thus, when the patient goes to the pharmacy two hours later, he simply presents his card 10 to the pharmacist and picks up the prescription. In the embodiments shown, one of the preferences the individual may have already selected for his or her prescriptions is payment method. Thus, when the pharmacy fills the prescription it also knows which payment method to use and can thus insure the prescription is both filled and paid for before the patient stops by to pick it up. FIG. 10 depicts a screen shot 210 of the system as it might be used at a doctor's office to provide prescription information.

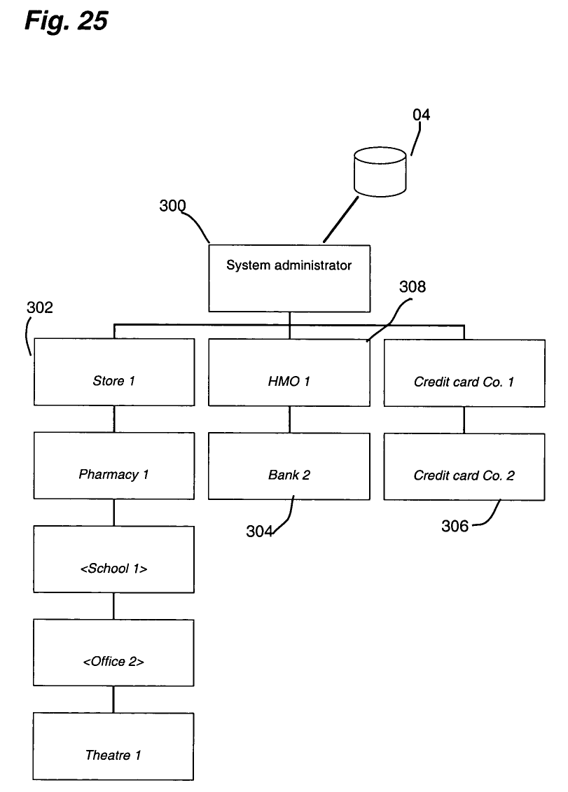

Turning briefly to FIG. 25, an illustrative set of participating organizations is shown. In FIG. 25, one company might serve as the system administrator 300 for the system of the present invention. Participating organizations might include credit card companies 306, retail stores or shops 302, banks 304, health maintenance organizations (HMOs) 308, and so on. In this network of participants, all would be equipped to read or scan identifiers 12, to access relevant portions of that entity's record information R on database 04.

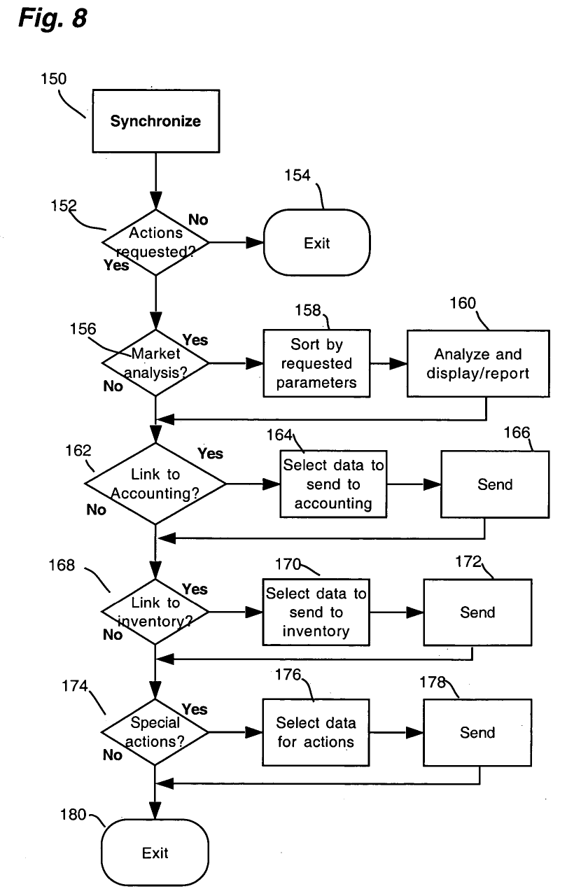

With reference now to FIG. 8, some of the other functions of the computer system 02 of the present invention are shown. The system synchronizes activities and reports in response to codes or requests. At step 152, a check is made to see if any actions are requested. If there is no activity, the synchronization program exits at step 154.

If actions are requested, at step 156, a check is made to see if market analysis is requested. If it is, sorts can be done at step 158 by parameters requested. For example, an authorized, participating company might like to know which items are top sellers in a certain age group on weekends. Database records can be sorted by these parameters and then analyzed at step 160, and a report printed or displayed. Those skilled in the art will appreciate that these requests can be in the form of SQL queries against a relational database. Scripted queries can be used as well. Similarly, data selected by sorting or other algorithms can be sent for further analysis to conventional analysis programs, such as linear regression programs, or statistical analysis programs that provide more detailed trend information. It is an aspect of the present invention that marketing information such as this is available in close to “real time.”

In the embodiment shown in FIG. 8, once any marketing requests are handled, the system checks at step 162 to see if a link to accounting is requested. Depending on the kinds of participants, some data may be selected at step 164 to be sent to accounting systems at step 166. Other participants may want to request links to inventory or other systems at steps 168-172. At step 174, special actions can be recognized. The pharmacy example given above is an illustration of one of these. A similar special action is online ordering from grocery stores. An order can be entered from home or work by scanning in a card 10 with its identifier 12. A special action program will accept the list, forward it to the participating store, along with pre-selected payment method and pickup time. The store can have staff pick up the ordered items, scan them through for payment and to compile an itemized list stored in database 04, so that the ordered items are packed and ready for pickup by the customer at the selected time. Again, the compilation of ordered items stored in database 04 acts as a receipt for the items, if one or more needs to be returned.

Still in FIG. 8, another example of special actions might be employee expense reporting. Many companies are able to negotiate special discounts for their employees based on company size and industry. If an employee is traveling at company expense, the present invention allows an employer to provide an employee with a card 10, with a unique identifier 12 for that employee with some pre-selected goods and services already paid for recorded in database 04. Hotels, moving companies, and restaurants that offer discounts to the company could also be pre-selected. Thus, the employee gets the benefit of paid expenses, and the employer has the benefit of reduced rates and more control over fixed choices and costs.

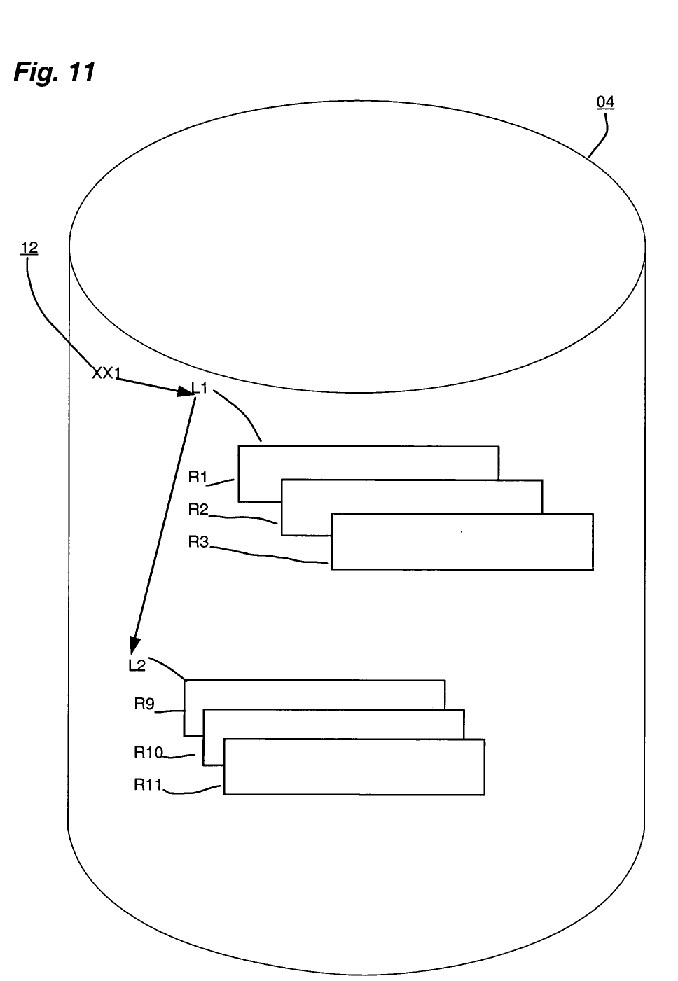

With reference now to FIG. 11, it can be seen the record information R about an entity can also be stored in libraries L in database 04. In the example shown, library L1 might contain general receipt information, while library L2 might contain medical records R9 through R11. It is an aspect of the present invention that the use of libraries also permits additional security safeguards to be implemented. For example, store receipts might be “locked” by the stores when they are entered, to prevent tampering. That is, the receipt data can be stored with read only permission for its access. Medical record information, might also be locked and protected with a distinct password as well for access. For example, a doctor and patient might agree on a password to use for that patient's medical records. Those skilled in the art will appreciate that libraries L can be created as protected or locked tables or subclasses within database 04 without deviating from the spirit of the present invention.

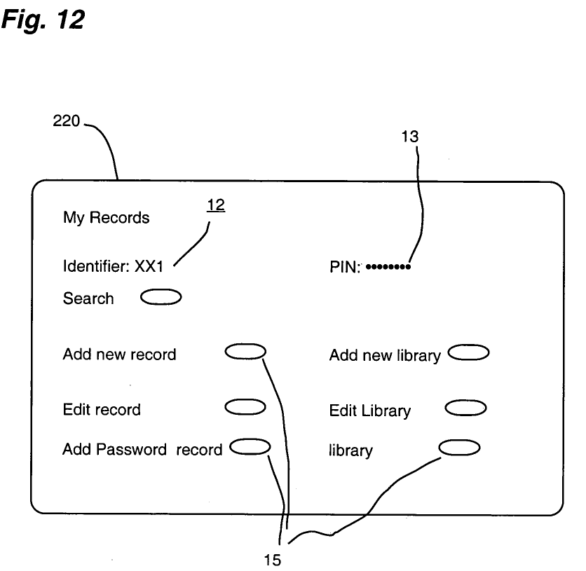

Now referring to FIG. 12, a screen display 220 for an entity's use is shown. In the embodiments shown, a user of card 10 with identifier 12 can also enter data using a home computer as terminal 06. In the embodiment shown in FIG. 12, card 10 has been scanned with an inexpensive home scanner to bring up screen 220 (displayed by the software of the present invention) on the entity's home computer, showing identifier 12. In this example, the entity has also elected to use a Personal Identification Number (PIN) to further authenticate access to database 04. Screen display 220 shows several options that are available to the user as “buttons” 15. If one of these is selected, such as “Add new record”, for example, the system will allow the entity to store a new record R in database 04, or the user might wish to add a new library L. The using entity can then characterize the added record(s) or library and submit data for them using traditional computer techniques, such as keyboard entry, scanned images, and so on.

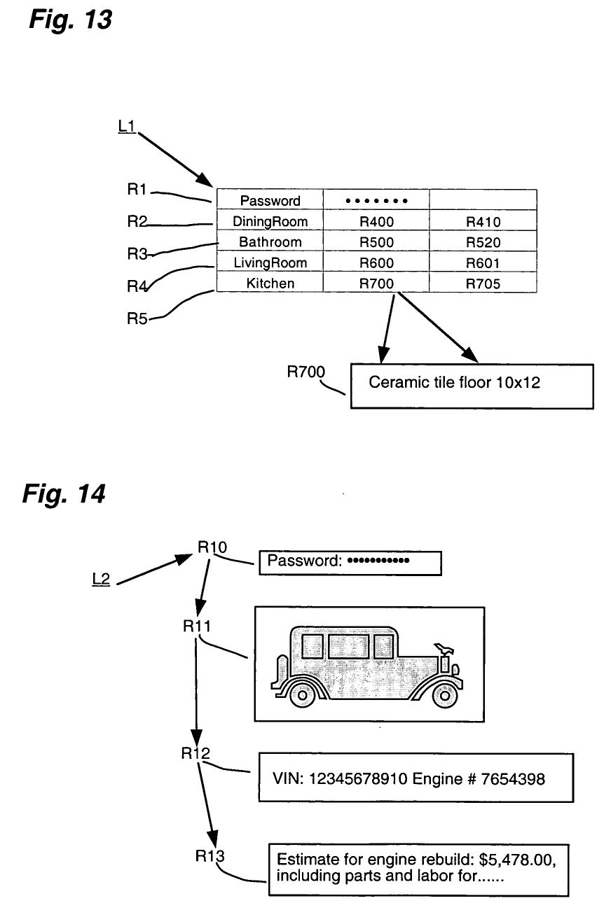

With reference now to FIG. 13, an example of such a new library is shown. In this example, the entity is storing information about planned home renovations. This library is password protected, as shown at record R1. Record R5 points to kitchen related records R ranging from record R700 to R705. R700 indicates the entity's plans to have a ceramic tile floor of 10 by 12 feet in the kitchen. It is an aspect of the present invention that the entity can permit a third party, such as a contractor, to have access to this library L1, if the contractor uses identifier 12 and the password used in record R1 for the library. Thus, the entity might wish to have several contractors submit bids for providing the kitchen flooring, by submitting bid estimates as records R for database 04.

Turning now to FIG. 14, a similar example of the use of identifier 12 and database 04 is shown. In this password-protected library L2, a picture of an antique automobile has been scanned in as record 11, and associated information about it has been entered in record 12. A contractor has supplied an estimate for an engine rebuild for the antique automobile in record R13.

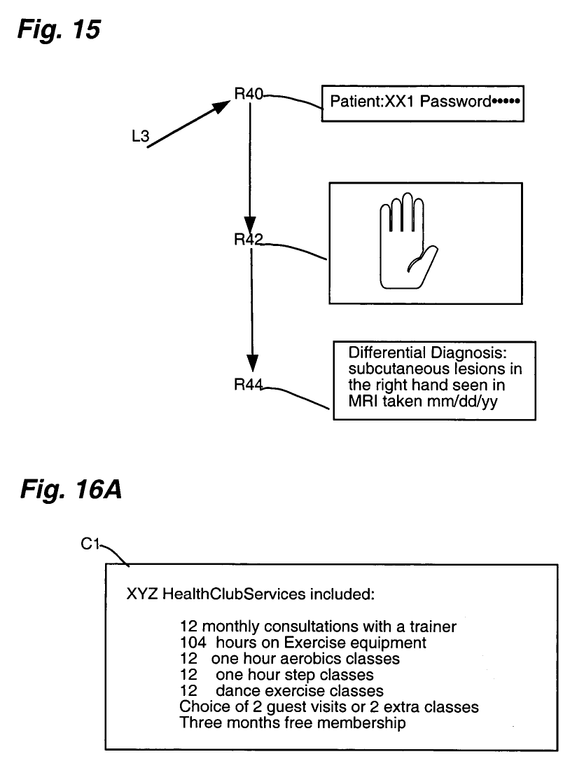

With Reference now to FIG. 15, another example of a library L3 of the present invention is shown. In this example, Record R40 contains a patient identifier 12 as well as a password for protecting access to the rest of the patient's records in medical library L3. Record R42 is a scanned MRI image of a hand and record R44 is a text entry containing a differential diagnosis.

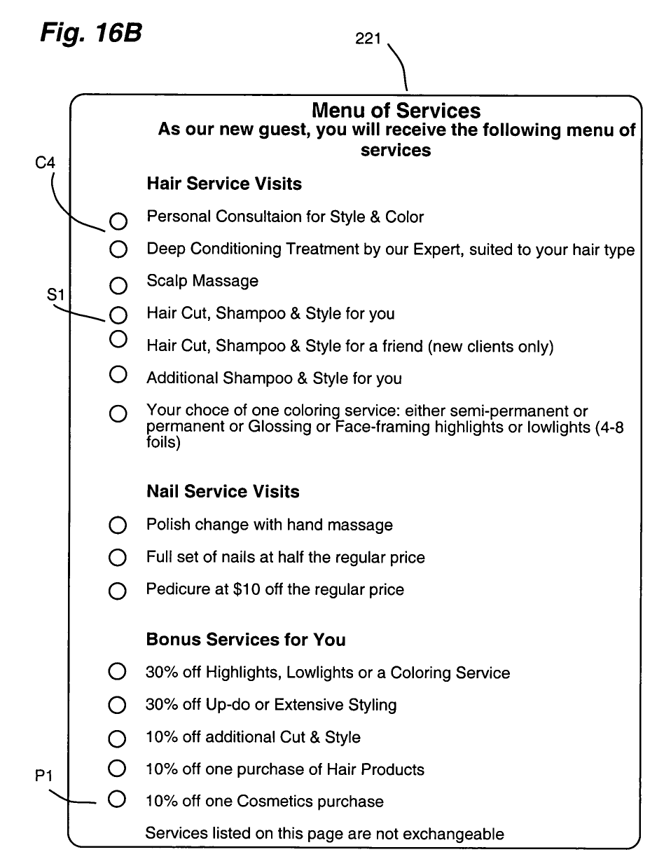

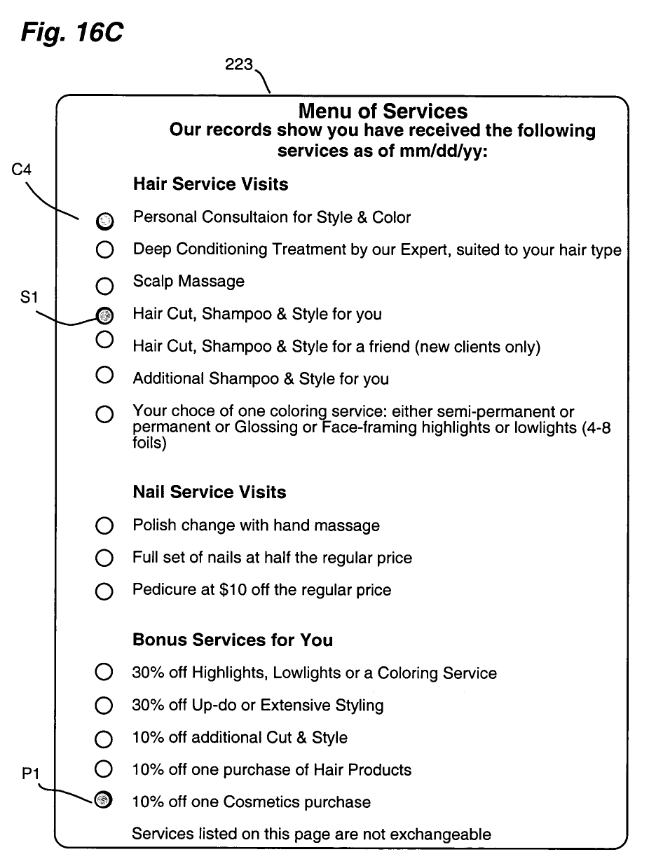

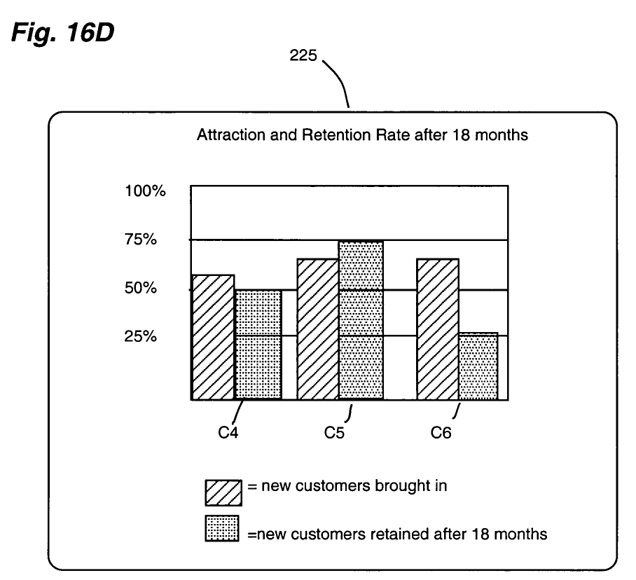

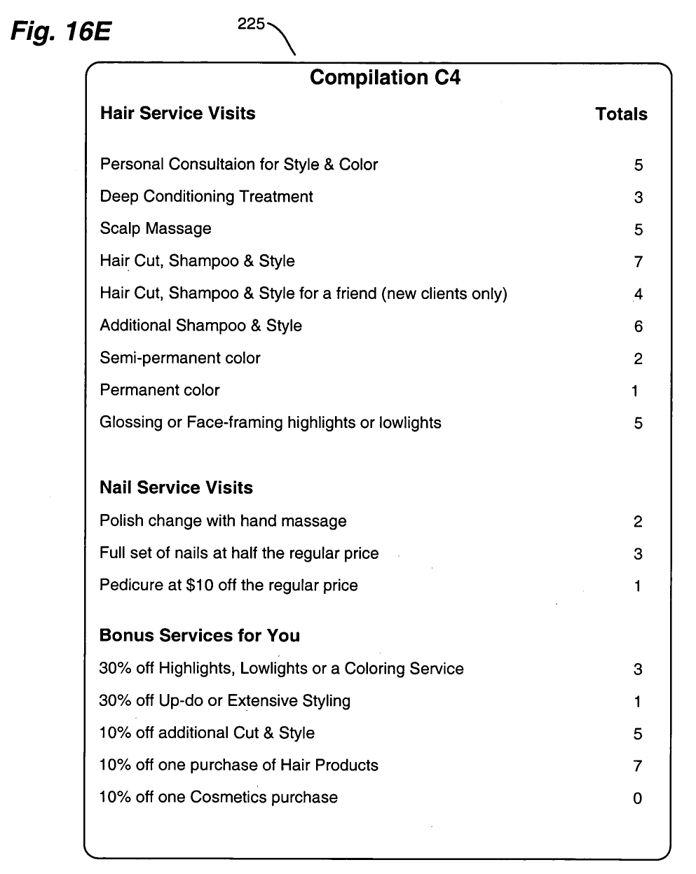

Now turning to FIG. 16A, a compilation C1 of services stored in database 04 is shown. In this example, an entity has purchased from a health club a set of services that are stored in database 04 and activated by use of card 10 and identifier 12. It is an aspect of the present invention that database 04 can be updated as the services are used or consumed. In the past, businesses have made packages of services or products like this available for an introductory or discounted price, to attract new customers or to test market new items. However, many businesses did not have sufficient technology resources to make the most use of the information gained from the purchase of such packages. Either they had to modify their own custom internal systems to track and analyze the sale and use of the packages or they had to keep track of the information manually. The present invention enables a business to issue a card 10, or become a participating issuer in a larger group of businesses, so that when purchases of packaged goods or services like this are made, the business can track the use or consumption of goods and services. Additionally, where, in the past, a business might have had to offer open-ended discounts on all goods and services to attract new customers, the present invention allows a business to specify discounts for those products or services most likely to bring in new business. The present invention also helps to identify what those products and services might be.

In the health club example of FIG. 16A, it may turn out that the majority of buyers do not use more than one consultation with a trainer over a year's time but almost everyone brings at least one guest. This information might help the business revise its service offerings to more popular ones and might also help the business attract even more new members by offering extra guest passes in the next package.

FIG. 16B illustrates a compilation C4 that might be offered as a package by a beauty salon. In this example, a compilation C4 of services S1, such as hair cuts and styling, and products P1, such as cosmetics, is offered as a discounted package. When this compilation C4 is purchased and the record of this purchase is stored in database 04, the present invention allows an entity to use identifier 12 and card 10 of the present invention to redeem the goods and services previously purchased, since that entity's entries in database 04 have been updated to reflect the purchase. Similarly, as is shown in FIG. 16C, as the goods or services of compilation C4 are used by the entity, this is reflected in database 04 and can be viewed by the entity over the Internet as illustrated in the screen shot 223 of FIG. 16C.

In FIG. 16C, it can be seen that the entity has used service S1 and product P1 as of a specified date. The entity thus knows what goods and services are still available and the participating beauty salon also knows which goods and services are selling first.

With reference now to FIG. 16D, it can be seen that several compilations C can be analyzed over a specified time period to determine which is most successful not only at attracting new customers, but at retaining those customers for the business. Thus, in this hypothetical case, if the beauty salon has offered three different compilations C, C4, C5 and C6, simple SQL queries or analysis programs can be used with the present invention to analyze the number of current customers brought in initially and then retained, in this case, for at least 18 months, by the various compilations C. The results illustrated in FIG. 16D show that while all three packages are fairly evenly matched at bringing in new customers, compilation C6 has the least success at inducing those customers to return as permanent customers, while compilation C5 is good at both attracting new customers and encouraging them to return.

The owner of the salon in the hypothetical example of FIG. 16D might then analyze the contents of each compilation C further, to determine which elements are most used and least used. In the example shown in FIG. 16D, it can be seen that most of the services and products had some use by the entities involved, but no one bought cosmetic products at the 10% discount. If, in our example from FIG. 16C, compilations C5 and C6 did not include any cosmetic product offerings or discounts, the salon owner might well conclude that cosmetic purchases are not a strong incentive either for attracting new customers or retaining existing ones. Similarly, after studying the comparison of the three compilation C packages, the owner might conclude that certain services and products, such as coloring and hair products appear to be stronger than expected factors in attracting and retaining customers. It is an aspect of the present invention that it is relatively simple for a participating store to use the present invention as part of its point of sales system to track and analyze customer preferences as described above.

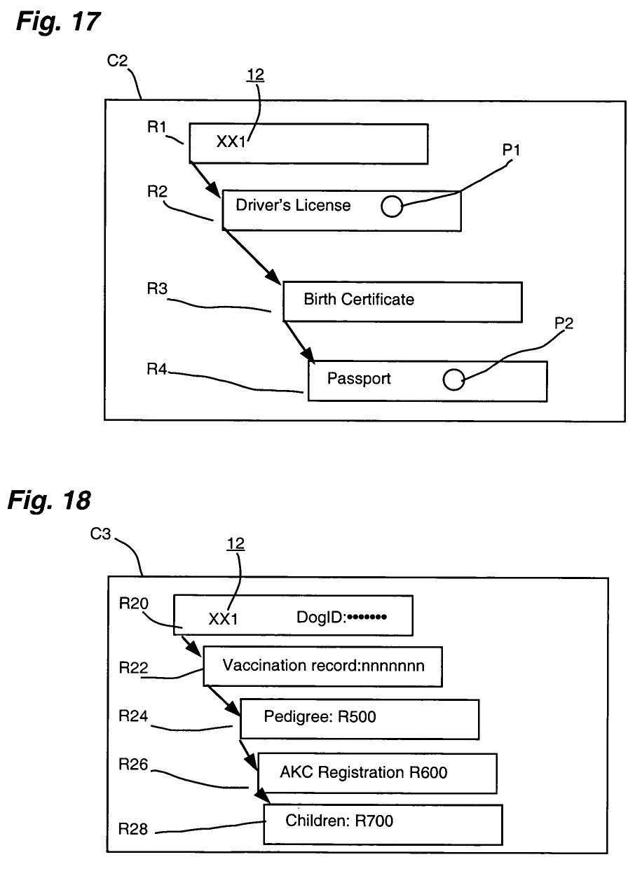

In FIG. 17, another compilation C is shown, this time compilation C2 is an identity compilation, referring to identifier 12 and linking to a “locked” record R2 containing a scanned image of a driver's license with a picture identity P1. Those skilled in the art will appreciate that governmental agencies might also benefit from the use of cards 10 and identifiers 12 of the present invention to minimize paperwork and loss of papers.

FIG. 18 is another illustration of the use of identifier 12 of the present invention in connection with dog Id's and records. The owner of a dog might create a compilation C3 containing the dog's vaccination records R22 from the veterinarian, the dog's pedigree from the breeder's records R24, the dog's American Kennel Club registration certificate record R26, and records R28 identifying the dog's offspring. Another implementation of the present invention would be an identifier 12 for the dog itself, in the form of small plastic id tags that can be scanned by city personnel or veterinarians to determine ownership of runaway dogs or to insure a dog has been properly vaccinated. In a similar vein, unique identifiers 12 might be assigned to works of art for tracking royalty information.

As mentioned above, the present invention can also be used to eliminate the need for paper tickets at events and concerts or for travel and transportation. Individuals can purchase tickets, using card 10 and identifier 12 and their preferred payment method, while the ticket seller sends the purchase data to database 04. In some of the embodiments shown, the buyer can use identifier 12 of card 10, along with a selected payment method, to purchase tickets online. Then the buyer simply presents card 10 at the event or travel facility to have the card scanned with identifier 12 and the stored receipt verified in database 04. Thus, the present invention can minimize or eliminate time spent by buyers in long lines waiting to buy tickets. Consequently, the organization using the present invention to process admissions can potentially reduce its own costs for handling crowds and lines or keep them lower than they might otherwise have been, if traditional paper tickets or admissions had been used.

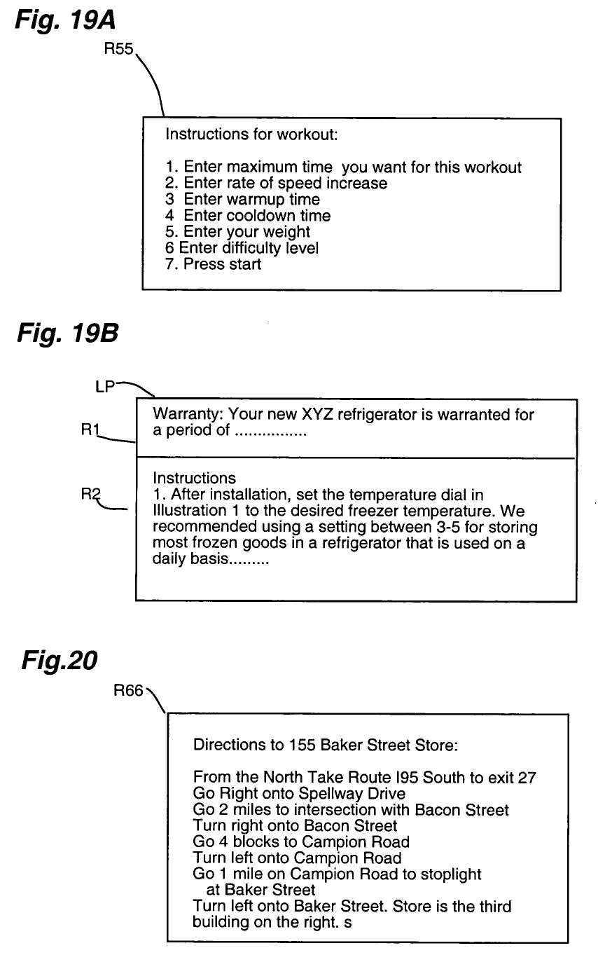

Turning now to FIG. 19A, an implementation of the present invention for providing instructions is shown. In this example, card 10 and identifier 12 can be used to activate an exercise machine at a health club and also get instructions from record R55 on how to use the machine.

Another variation of this might involve using card 10 and identifier 12 to download instructions on a new purchase, as is illustrated in FIG. 19B, where warranty information on a newly purchased refrigerator is stored in library LP as record R1 and instructions are stored in library LP as record R2. Manufacturers can provide this information to users of the present invention in several ways. Instead of packaging paper instructions and warranty data, the manufacturer could provide this information on a CD-ROM, which the purchasing entity can read into its library LP at the time it registers its warranty with the manufacturer. In this case, the entity would use a home computer and scanner to read in identifier 12, or type in identifier 12 if it is numeric or alphanumeric, access database 04 and upload the information from the CD-ROM into library LP. Alternatively, the manufacturer could make this information available to purchasers who register at the manufacturer's website using identifier 12. In that example, the manufacturer would relay the warranty and instruction information to Library LP for identifier 12 in database 04.

FIG. 20 illustrates how the present invention can be used to obtain a previously stored compilation of driving directions from database 04. In this example, terminal 06 is a cellular or wireless telephone, capable of sending and receiving text messages, which is used to transfer identifier 12 as a text message to database 04 and request a directions record R66 stored in database 04. Those skilled in the art will appreciate that several manufacturers now make such cellular telephones, including Sony Ericsson™, and Nokia™, among others. Networks such as AT&T™ wireless permit the sending and receiving of text messages between cellular telephones and centralized databases.

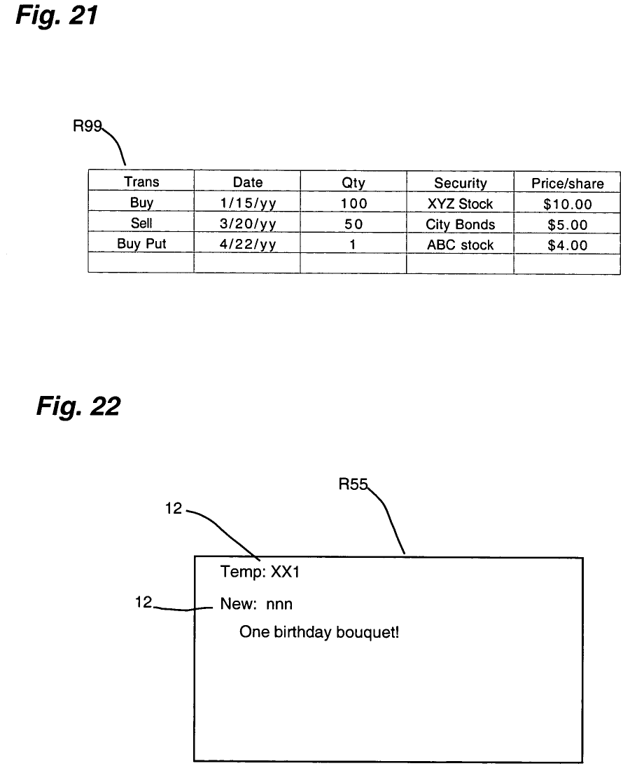

With reference now to FIG. 21, a compilation record R99, from database 04 of recent financial investment transactions is shown. In the same way that identifier 12 can be used to store receipts when purchasing items, it can also be used to record transactions when buying or selling securities through a participating brokerage or securities firm or bank.

It is an aspect of the present invention that its use can often significantly reduce paper costs or labor costs or both. For example, the use of the present invention to replace paper tickets can reduce paper costs significantly. Similarly, if card 10 and identifier 12 of the present invention are used by participating companies at terminals 06 at events or travel facilities for admissions, the number of staff required to process admissions can also be reduced, depending on the implementation.

FIG. 22 illustrates yet another embodiment of the present invention. Businesses have used cash gift cards for some time. Since they only represent a cash amount, they are somewhat impersonal for the recipient and self-limiting devices for the businesses as they do very little to make the recipient a regular customer. The present invention enables an entity to purchase a particular present for someone, have that purchase recorded in database 04 as record R55 in this example, and have a new card 10, reflecting the present to give to the recipient. The new card 10, might have a temporary identifier 12, which will identify the gift, but will also allow the gift recipient to select a permanent identifier 12 or use a pre-existing identifier 12, to become a regular customer of that business. This enables businesses to capture new customers who come in to redeem gifts. In this example, if the new customer does not yet have an identifier 12 according to the present invention, the business can create a new card 10 with a new identifier 12 for the new customer, using card printers now available. In addition to capturing new customers, businesses can also use this approach to direct the gift givers to specific products or services that need to be sold for inventory and new buying purposes or to packages of products or services. It can also help to increase in-store traffic when the recipient comes to the store to pick up the present.

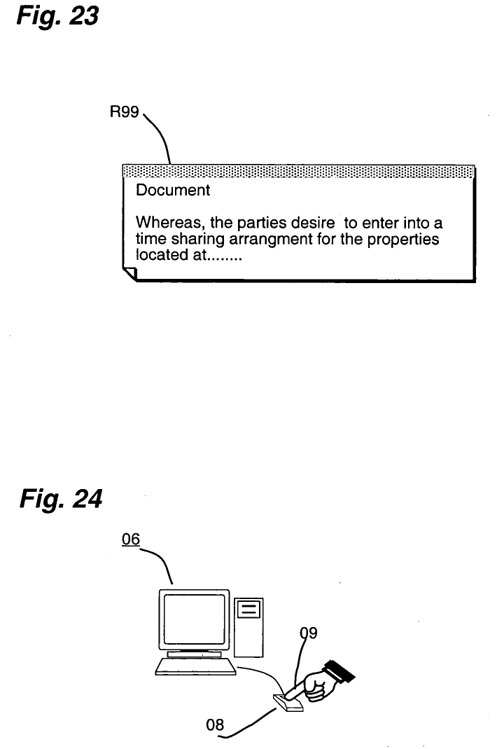

In FIG. 23, still another aspect of the present invention is shown. In this example, identifiers 12 can be assigned on a one-time basis to several people reviewing a document such as that shown in R99 of FIG. 23. For this purpose, each identifier 12 might be valid only for a short time, to permit review and comments. Alternatively, permanent identifiers 12 can be used by individual reviewers, and temporary passwords assigned to each new version of the document shown in record R99. This provides for a more secure review and approval process when sensitive information is shared across long distances. Where strict security is required, as for example, in a large law office handling very sensitive documents, the present invention can also be used to keep track of who had access to the document, since each use requires the entry of an identifier 12 and a password.

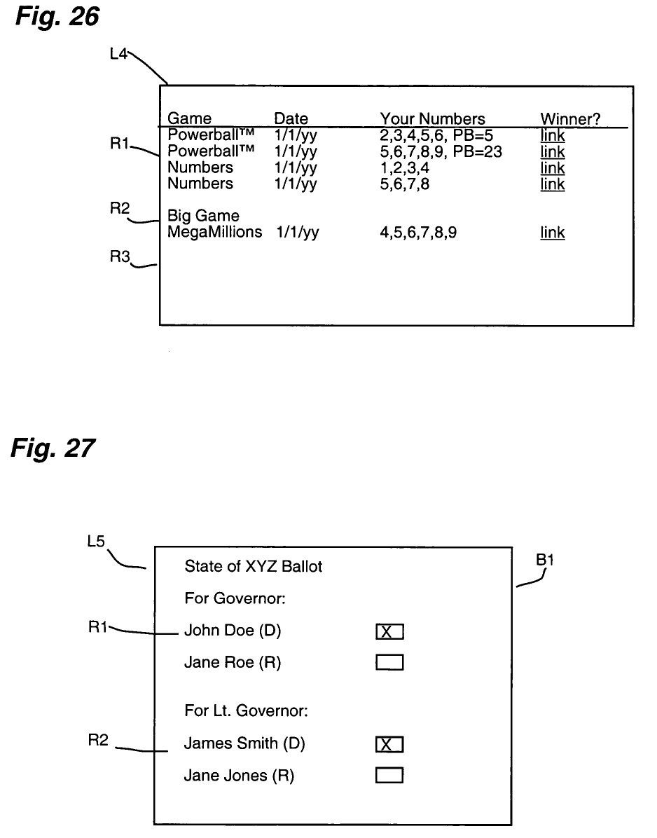

Turning now to FIG. 26, still another aspect of the present invention is shown. In this example, identifier 12 can be used with card 10 for lottery ticket purchases. This minimizes or eliminates the need for paper tickets and problems arising from the loss of them. Participating lottery agencies would store lottery numbers selected by the entity in a separate library L3 associated with that entity. In this example, three sets of lottery numbers, as reflected in records R1-R3, have been purchased by an entity for the games indicated on the dates indicated. When the entity purchases the tickets, it uses card 10 with identifier 12 at a ticket purchase location to identify itself and request that they be stored in that entity's library L3. The entity can also use card 10 and identifier 12 to check at other lottery locations or even at home, to see if those selections are winning numbers. In the embodiment shown, the participating lottery agencies could also have calculated the results and posted links to them to all ticket-buying customers in their respective libraries L4 in database 04. This latter is-the kind of service that the lottery agencies might fund through charging additional fees. Alternatively, lottery agencies might also offer games that allow people to select and purchase lottery numbers with home computers and store the numbers in database 04 using the present invention. This could eliminate or reduce third party commission payoffs, netting more income for the states and municipalities offering the lotteries.

Those skilled in the art will also appreciate that something similar to the illustration of FIG. 26 could be implemented for various other types of games and prizes. For example, participating merchants could use the present invention to conduct contests and award daily prizes by encouraging use of card 10 and identifier 12 to enter the contests and track the prizes.

With reference now to FIG. 27, yet another aspect of the present invention is shown. In this example, the present invention can be used for voting purposes, either on a governmental level or for non-governmental voting. In this example, the entity might be a registered voter. As part of the registration process, a card 10 with an identifier 12 could be issued to the entity along with one or more additional identifiers such as a library password or a PIN number. Alternatively, the entity could present its pre-existing card 10 and identifier 12 in order to register. In still another variation, if a biometric is used as identifier 12, the biometric is presented for registration.

In this example, registration would assure that a final, interactive ballot B1, would be stored as one or more records R1-Rn, in that entity's voting library L5. The ballot could be stored in such a way as to be usable only during the official voting period by putting time activated locks and unlocks on the records in the ballot. Thus, if the voter is not voting as an absentee voter, a 24-hour time period can be used. Alternatively, if the voter registers as an absentee voter, a longer time period can be assigned, in accordance with local voting laws.

An advantage of this use of the present invention for voting purposes is that it can eliminate long lines at the polls and greatly simplify the process for the voters and the election officials. Depending on the implementation, the voters might be able to use home computers to cast their votes, by scanning in their identifiers 12 using a scanning device at home to access a website where the ballot B1 appears. Once a vote is cast and the system verifies that the entity wants to make it final, the result can be stored in that voter's library L5 in a locked record as well as tabulated by the election officials and stored in their computer databases. This use of the present invention might also help to increase voter turnout since votes can now be cast from home or the office.

Absentee voters might also be able to send in their votes from any location, using a portable scanner and a laptop computer or even a cellular telephone. Depending on the degree of security desired, special cards 10 and identifiers 12 can be issued by the election officials; or biometrics or other uniquely generated codes can be used as identifier 12, along with other security safeguards without deviating from the present invention.

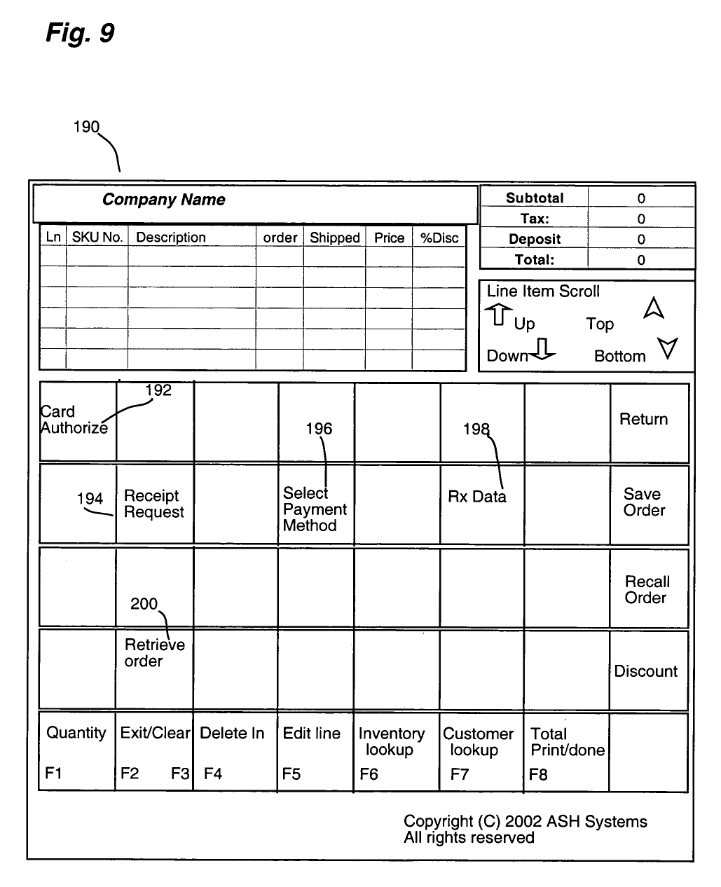

Now referring to FIG. 9, a commercial implementation of the present invention shows the use of a touch pad screen 190 as part of terminal 06. The embodiment shown is implemented using a modified version of a Point of Sale Management System from Ash Systems, Inc. In this example, the touch pad screen might be located at a pharmacy. Once the entity has presented its card 10, it is scanned at terminal 06, so that identifier 12 can be read and sent to the database 04 as described above. After it has been verified, the clerk using terminal 06 might push pad 198, to get the prescription data for this entity. In the embodiment shown, if this information had been previously sent to the pharmacy by the healthcare provider as described above, the information about the prescription(s) would then be sent to terminal 06 and appear as line items with SKU's descriptions, and prices at the top of the screen. If the order has already been paid for, the clerk would simply push pad F8 for Total Print/done. Touch pad screens, such as that shown in FIG. 9 are manufactured by companies such as 3M and ELO among others, for use in connection with computers to form a workstation or, in the case of the present invention, terminal 06. In this embodiment, a touch screen monitor, a computer with a keyboard, a scanner, and a printer might comprise terminal 06, together with the software.

Those skilled in the art will appreciate that a number of standard security measures can be used to protect the information sent to and from database 04 from such a terminal 06. At the terminal, clerks or users of participating organizations typically identify themselves using passwords when they log in. Data being transmitted can be sent using standard encryption techniques provided with most conventional networking software to prevent interception during transmission. Referring briefly to FIG. 1, conventional firewalls and similar safeguards can be used at computer system 02 and database 04, to prevent improper access. Similarly, entity information can be stored in database 04 in password protected libraries L, such that participating organizations can have access to the information in some of the libraries L, for storing receipts and data analysis purposes, but not have access to personal identification data or personal information to which an entity desires to restrict access.

Now turning to FIG. 24, an alternative form of identifier 12 is shown. In this example, identifier 12 is a biometric, such as a fingerprint. In the embodiment of FIG. 12, terminal 06 has a biometric fingerprint scanner 08 communicating with it. When the entity's finger 09, is placed on fingerprint scanner 08, the fingerprint is scanned and can be compared with a master fingerprint on file in database 04 for verification. Fingerprint scanners the size of a computer mouse are available from companies such as Biologon. Other biometric devices, such as hand readers are available from companies such as Locknetics, Inc. Still other types of biometrics can be used without deviating from the spirit of the present invention. For example, iris scanners, gait recognition, ear shape recognition and so on, are various other forms of biometric identifiers 12 that can be used to associate an entity with a set of information records R in database 04. An aspect of using biometric identifiers 12 is that security is typically enhanced, since the biometric identifiers 12 are typically more difficult to forge or “hack” or duplicate. Certain types of identifiers 12 may be more appropriate for certain types of records R. Voting, for example, may require more advanced, secure forms of identifiers 12.

In the embodiments shown, a modified point of sale systems from Ash Systems, Inc. written in Microsoft's Visual Foxpro™ relational database software has been used. This system makes use of client/server technology for multi-site implementations and runs on Microsoft Operating Systems such as Windows 98™, Windows 2000™, Windows XP™, and so forth, on IBM™-compatible personal computers and workstations. Those skilled in the art will appreciate that other database software, point of sale software, application software, client server software, and operating system software can be used or modified for use without deviating from the spirit of the present invention. Similarly, other types of computer hardware, such as Apple Macintosh™ computers, IBM™ mainframe computers, Silicon Graphics™ workstations, and so on, can be used without deviating from the spirit of the present invention.

In some of the embodiments shown, card 10 is used to carry identifier 12 as a magnetic stripe or bar code. However, as shown in FIG. 24, a card 10 may be replaced entirely simply by using a biometric, such as a fingerprint as identifier 12 when the entity is an individual.

As noted above, terminal 06 can be any of a number of different types of products or technologies, from a cellular telephone or personal Digital Assistant (PDA) capable of transmitting and receiving text messages, to a workstation with a computer, scanner, touch screen, printer and other peripherals. Scanners for magnetic stripe cards or bar code scanners are readily available from a number of manufacturers, such as Id Tech or Mag Tek and small, inexpensive, and portable card readers are available from such companies as well. As mentioned above, biometric scanners are available from companies such as Biologon and Identix.

Similarly, database 04 in the embodiments shown is stored on magnetic disk drives known as hard drives at a central computer site, but those skilled in the art will appreciate that database 04 could be stored on any device capable of being read and written by a computer or similar apparatus. Additionally, while some of the present invention is implemented as software modifying a point of sale system, those skilled in the art will appreciate that some or all of the software could also be implemented as firmware or even fixed circuitry.

A portion of the disclosure of this invention is subject to copyright protection. The copyright owner permits the facsimile reproduction of the disclosure of this invention as it appears in the Patent and Trademark Office files or records, but otherwise reserves all copyright rights.

What is claimed is:

1. A system comprising:
a database containing record information associated with an identifier for an entity;
a device acting as an identifier for the entity, the identifier not having any cash value and not having any credit value;
a terminal capable of relaying record information associated with the identifier from the device to and from the database over a communications pathway so that record information associated with the entity can be communicated to and from the database.

2. The system of claim 1, wherein the database and the communications pathway are capable of relaying information to a second terminal.

3. The system of claim 1, wherein the device further comprises a card having a magnetic stripe encoding the identifier for the entity.

4. The system of claim 1, wherein the device further comprises a card having a bar code encoding the identifier for the entity.

5. The system of claim 1, wherein the device further comprises a biometric.

6. The system of claim 1, wherein the device further comprises a magnetic stripe encoding the identifier included on a credit card.

7. The system of claim 1, wherein the device further comprises a magnetic stripe encoding the identifier included on a cash card.

8. The system of claim 1, wherein the device further comprises a magnetic stripe encoding the identifier included on a membership card.

9. The system of claim 1, wherein the device further comprises both a magnetic stripe and a bar code encoding the identifier included on a card.

10. The system of claim 1, wherein the device further comprises a keyboard capable of being used to enter the identifier from a terminal.

11. The system of claim 1, wherein the device further comprises a scanner capable of being used to scan the identifier into a terminal.

12. The system of claim 1, wherein the record information further comprises a method of payment.

13. The system of claim 12, wherein the method of payment further comprises a credit card number.

14. The system of claim 12, wherein the method of payment further comprises a debit card number.

15. The system of claim 12, wherein the method of payment further comprises checking account information.

16. The system of claim 12, wherein the method of payment further comprises wire transfer information.

17. The system of claim 1, wherein the record information further comprises purchase receipt information.

18. The system of claim 17, wherein the purchase receipt information contains a description of the item purchased.

19. The system of claim 2, wherein the record information includes healthcare information.

20. The system of claim 19, wherein the record information further comprises prescription data for the entity to be relayed to the database.

21. The system of claim 19, wherein the record information further comprises medical record information about the entity to be relayed to the database.

22. The system of claim 19, wherein the terminal is located at a healthcare facility so that prescription data can be relayed from the healthcare facility to the database.

23. The system of claim 22, wherein the second terminal is located at a pharmacy so that the pharmacy may relay the identifier for the entity to the database to authorize dispensing the prescription to the entity.

24. The system of claim 1, wherein the record information further comprises insurance information.

25. The system of claim 2, wherein the record information further comprises a compilation.

26. The system of claim 25, wherein the compilation further comprises a list of items to be purchased and available for pickup.

27. The system of claim 25, wherein the compilation further comprises a list of services to be purchased and made available on a schedule.

28. The system of claim 25, wherein the compilation further comprises a package of goods and services pre-purchased by an entity.

29. The system of claim 25, wherein the compilation further comprises instructions.

30. The system of claim 25, wherein the compilation further comprises directions.

31. The system of claim 25, wherein the compilation further comprises a list of previously purchased items and services.

32. The system of claim 25, wherein the compilation further comprises automobile registration and insurance information.

33. The system of claim 25, wherein the compilation further comprises records of financial transactions.

34. The system of claim 25, wherein the compilation further comprises personal record information.

35. The system of claim 25, wherein the compilation further comprises reports of grades and test results.

36. The system of claim 2, wherein the record information further comprises government licensing and permission information.

37. The system of claim 2, wherein the record information further comprises voting information.

38. The system of claim 2, wherein the record information further comprises information about games of chance.

39. The system of claim 2, wherein the record information further comprises purchased ticket information which information is capable of being relayed to a second terminal.

40. The system of claim 1, wherein the identifier further comprises a unique number assigned to the entity together with a personal identification number selected by the entity.

41. The system of claim 1, wherein the identifier further comprises a biometric.

42. The system of claim 1, wherein the record information is organized into a library.

43. The system of claim 42, wherein the record information in the library can be locked into read-only format.

44. The system of claim 42, wherein the library is capable of being protected by password security.

45. The system of claim 44, wherein the record information further comprises a document for review and comment.

46. The system of claim 1, wherein the database further comprises a storage system which can be read and written by a plurality of participants.

47. A method comprising the steps of:
storing record information associated with an identifier for an entity in a database;
conveying the identifier in a device, the identifier not having any cash value and not having any credit value;
relaying record information associated with the identifier from a terminal capable of communicating with the device to and from the database over a communications pathway so that record information associated with the entity can be communicated to and from the database.

48. The method of claim 47, wherein the step of relaying information includes the step of relaying information to a second terminal.

49. The method of claim 47, wherein the step of conveying the identifier further comprises the step of encoding the identifier for the entity on a card having a magnetic stripe.

50. The method of claim 47, wherein the step of conveying the identifier further comprises the step of encoding the identifier for the entity on a card having a bar code.

51. The method of claim 47, wherein the step of conveying the identifier further comprises the step of using a biometric.

52. The method of claim 47, wherein the step of conveying the identifier further comprises the step of encoding the identifier in a magnetic stripe included on a credit card.

53. The method of claim 47, wherein the step of conveying the identifier further comprises the step of encoding the identifier in a magnetic stripe included on a cash card.

54. The method of claim 47, wherein the step of conveying the identifier further comprises the step of encoding the identifier in a magnetic stripe included on a membership card.

55. The method of claim 47, wherein the step of conveying the identifier further comprises the step of encoding the identifier in both a magnetic stripe and a bar code included on a card.

56. The method of claim 47, wherein the step of conveying the identifier further comprises the step of entering the identifier on a keyboard communicating with the terminal.

57. The method of claim 47, wherein the step of conveying the identifier further comprises the step of scanning the identifier into a terminal.

58. The method of claim 47, wherein the step of storing the record information includes the step of storing a method of payment.

59. The method of claim 58, wherein the step of storing a method of payment further comprises the step of storing a credit card number.

60. The method of claim 58, wherein the step of storing a method of payment further comprises the step of storing a debit card number.

61. The method of claim 58, wherein the step of storing a method of payment further comprises the step of storing checking account information.

62. The method of claim 58, wherein the step of storing a method of payment further comprises the step of storing wire transfer information.

63. The method of claim 58, wherein the step of storing record information further comprises the step of storing purchase receipt information.

64. The method of claim 63, wherein the step of storing purchase receipt information includes the step of describing the item purchased.

65. The method of claim 48, wherein the step of storing record information includes the step of storing healthcare information.

66. The method of claim 65, wherein the step of storing healthcare information includes the step of storing prescription data for the entity.

67. The method of claim 65, wherein the step of storing healthcare information further comprises the step of storing medical record information about the entity.

68. The method of claim 66, wherein the step of relaying information includes the step of locating a terminal at a healthcare facility so that prescription data can be relayed from the healthcare facility to the database.

69. The method of claim 68, wherein the step of relaying information includes the step of locating the second terminal at a pharmacy so that the pharmacy may relay the identifier for the entity to the database to authorize dispensing the prescription to the entity.

70. The method of claim 47, wherein the step of storing record information further comprises the step of storing insurance information.

71. The method of claim 48, wherein the step of storing record information further comprises the step of storing a compilation.

72. The method of claim 71, wherein the step of storing a compilation further comprises the step of storing a list of items to be purchased and available for pickup.

73. The method of claim 71, wherein the step of storing a compilation further comprises the step of storing a list of services to be purchased and made available on a schedule.

74. The method of claim 71, wherein the step of storing a compilation further comprises the step of storing a package of goods and services pre-purchased by an entity.

75. The method of claim 71, wherein the step of storing a compilation further comprises the step of storing instructions.

76. The method of claim 71, wherein the step of storing a compilation further comprises the step of storing directions.

77. The method of claim 71, wherein the step of storing a compilation further comprises the step of storing a list of previously purchased items and services.

78. The method of claim 71, wherein the step of storing a compilation further comprises the step of storing automobile registration and insurance information.

79. The method of claim 71, wherein the step of storing a compilation further comprises the step of storing records of financial transactions.

80. The method of claim 71, wherein the step of storing a compilation further comprises the step of storing personal record information.

81. The method of claim 71, wherein the step of storing a compilation further comprises the step of storing reports of grades and test results.

82. The method of claim 48, wherein the step of storing record information further comprises the step of storing government licensing and permission information.

83. The method of claim 48, wherein the step of storing record information further comprises the step of storing voting information.

84. The method of claim 48, wherein the step of storing record information further comprises the step of storing information about games of chance.

85. The method of claim 48, wherein the step of storing record information further comprises the step of storing purchased ticket information, which information is capable of being relayed to the second terminal.

86. The method of claim 47, wherein the step of associating an identifier further comprises the step of assigning a unique number to the entity together with a personal identification number selected by the entity.

87. The method of claim 47, wherein the step of associating an identifier further comprises the step of using a biometric.

88. The method of claim 47, wherein the step of storing record information includes the step of organizing the record information into a library.

89. The method of claim 88, wherein step of organizing the record information into a library includes the step of locking the record information into read-only format.

90. The method of claim 88, wherein the step of organizing the record information into a library includes the step of protecting the library by password security.

91. The method of claim 90, wherein wherein the step of organizing the record information into a library includes the step of storing a document for review and comment.

92. The method of claim 47, wherein the step of storing record information associated with an identifier for an entity in a database further comprises the step of using a storage system which can be read and written by a plurality of participants.

93. A machine readable medium for storing a system for storing record information associated with an identifier for an entity in a database, the system conveying the identifier in a device, the identifier not having any cash value and not having any credit value, the system being capable of relaying record information associated with the identifier from a terminal capable of communicating with the device to and from the database over a communications pathway so that record information associated with the entity can be communicated to and from the database.
